(19) United States
(12) Patent Application Publication
(10) Pub. No.: US 2026/0128203 A1
(43) Pub. Date: May 7, 2026

(54) TRANSFORMER

(71) Applicants: HAIHONG ELECTRIC CO., LTD., Jiangmen, Guangdong (CN); TRITYPE ELECTRIC CO., LTD., Jiangmen, Guangdong (CN)

(72) Inventors: Kaixuan XU, Jiangmen, Guangdong (CN); Qingning LIANG, Jiangmen, Guangdong (CN); Yuxiang QI, Jiangmen, Guangdong (CN); Danju SONG, Jiangmen, Guangdong (CN); Fei LI, Jiangmen, Guangdong (CN); Huilin GUAN, Jiangmen, Guangdong (CN); Wenjie FANG, Jiangmen, Guangdong (CN); Yucheng ZHOU, Jiangmen, Guangdong (CN); Xueming ZHANG, Jiangmen, Guangdong (CN); Huaming WANG, Jiangmen, Guangdong (CN); Weifeng TAN, Jiangmen, Guangdong (CN); Quanan XU, Jiangmen, Guangdong (CN)

(73) Assignees: HAIHONG ELECTRIC CO., LTD., Jiangmen, Guangdong (CN); TRITYPE ELECTRIC CO., LTD., Jiangmen, Guangdong (CN)

(21) Appl. No.: 19/119,399

(22) PCT Filed: Feb. 15, 2023
(86) PCT No.: PCT/CN2023/076201

§ 371 Date: Apr. 8, 2025

(30) Foreign Application Priority Data
Oct. 13, 2022 (CN) 202211253107.8

(51) Int. Cl. H01F 27/06; H01F 27/24; H01F 27/28

(52) U.S. Cl. CPC H01F 27/06; H01F 27/24; H01F 27/28

(57) ABSTRACT

A transformer includes: a base a transformer body, and a clamping assembly. The clamping assembly is mounted on one side of the base. A clamping gap is formed on the clamping assembly in a vertical direction. The transformer body is supported on the clamping assembly and is clamped in the clamping gap.

### TECHNICAL FIELD

The present disclosure relates to the technical field of transformers, and in particular, to a transformer.

### BACKGROUND

A transformer is an apparatus that changes AC voltages based on the principle of electromagnetic induction, and its main components are a primary coil, a secondary coil and an iron core (magnetic core). Clamps are disposed on the upper and lower parts of the iron core of a traditional transformer, and the clamps are mainly configured to fix and support the entire iron core and coil.

Traditional clamps are generally made of carbon steel. Due to the conductivity of the carbon steel, when the transformer is over-voltage or struck by lightning, the charged bodies, such as coil or lead wire, may discharge to the clamps, which may cause transformer failures in serious cases. At the same time, although the clamps can clamp the iron core and compress the coil, the clamps also block part of the heat dissipation areas of the iron core and the coil, thus having a certain influence on the heat dissipation of main heating elements such as the transformer core and coil. Further, the traditional clamps require pickling, phosphating and painting during the production process, which is harmful to the environment. In addition, the clamp has a long production, labor-intensive, low efficiency and high cost process, which affects the production of the transformer.

### SUMMARY

For this reason, it is necessary to provide a transformer to address the defects problems in the structure and production process of traditional transformer clamps. A clamping assembly used in the transformer can avoid blocking heat dissipation areas of an iron core and a coil, and the production process of the clamping assembly is harmless to the environment, and can effectively shorten the production process and reduce the labor intensity.

According to one aspect of the present disclosure, a transformer is provided, which includes:
a base;
a clamping assembly mounted on one side of the base, where a clamping gap is formed on the clamping assembly in a vertical direction; and
a transformer body supported on the clamping assembly and clamped in the clamping gap.

In one embodiment, the clamping assembly includes a first clamping unit including a first tightening screw, an upper pressing plate and a lower pressing plate. The first tightening screw is mounted on the base at one end of the first tightening screw. The upper pressing plate and the lower pressing plate are sleeved on the first tightening screw at intervals, so that a first clamping gap configured to clamp and support the transformer body is formed between one side, facing the lower pressing plate, of the upper pressing plate and one side, facing the upper pressing plate, of the lower pressing plate, and the first clamping gap being used.

In one embodiment, the clamping assembly further includes a plurality of second clamping units which are arranged at intervals along a circumferential direction and around an outer edge of the transformer body.

In one embodiment, each of the plurality of second clamping units includes a second tightening screw, an upper pressing block and a lower pressing block. The second tightening screw being mounted on the base at one end of the second tightening screw. The upper pressing block and the lower pressing block are sleeved on the second tightening screw at intervals, so that a second clamping gap configured to clamp and support the transformer body is formed between one side, facing the lower pressing block, of the upper pressing block and one side, facing the upper pressing block, of the lower pressing block.

In one embodiment, the transformer body includes:
an iron core arranged on the base; and
a coil sleeved on a core column of the iron core, where the coil includes a primary coil and a secondary coil, where the primary coil is coated outside the secondary coil in a circumferential direction.

In one embodiment, the transformer further includes a primary lead which electrically connects to an outgoing line of the primary coil, and has a primary terminal, and a secondary lead which electrically connects to an outgoing line of the secondary coil, and has a secondary terminal. Both the primary terminal and the secondary terminal are used for grid connection.

In one embodiment, the base includes a bottom plate and two support beams separated from each other. The bottom plate spans across the two support beams. The transformer body and the clamping assembly are mounted on one side of the bottom plate opposite the support beams.

In one embodiment, the transformer further includes an upper bracket including an upper bracket body disposed on the clamping assembly, and an iron core pressing plate mounted on the upper bracket body to compress the iron core.

In one embodiment, the transformer further includes a plurality of insulating struts which are arranged at intervals along a circumferential direction and around the transformer body.

According to the above-mentioned transformer, the clamping gap is formed on the clamping assembly in the vertical direction, and the transformer body is supported on the clamping assembly and clamped in the clamping gap. The clamping assembly can clamp the transformer body by adjusting the size of the clamping gap, and the clamping assembly does not block the heat dissipation areas of the iron core and the coil. The production process of the transformer is harmless to the environment, and is conducive to shortening the production process and reducing the labor intensity, thereby improving the production efficiency and reducing the cost.

### BRIEF DESCRIPTION OF DRAWINGS

FIG. 1 shows an assembly schematic diagram of a transformer according to an embodiment of the present disclosure;

FIG. 2 shows a front view corresponding to FIG. 1;

FIG. 3 shows a top view corresponding to FIG. 1;

FIG. 4 shows a schematic structural diagram of a base in FIG. 1;

FIG. 5 shows a schematic diagram of a partial structure of a transformer corresponding to FIG. 1; FIG. 6 shows a schematic diagram of a partial structure of a transformer according to another embodiment of the present disclosure;

FIG. 7 shows a schematic structural diagram of an iron core corresponding to FIG. 1;

FIG. 8 shows a top view of an iron core corresponding to FIG. 7; and

FIG. 9 shows a schematic structural diagram of an upper bracket corresponding to FIG. 1.

### LIST OF REFERENCE NUMERALS

Transformer 100; base 110; bottom plate 111; mounting hole 1111; support beam 112; transformer body 120; iron core 121; single iron core frame 1211; coil 122; primary coil 1221; secondary coil 1222; insulating gap 1223; clamping assembly 130; clamping gap 131; first clamping unit 132; first tightening screw 1321; upper pressing plate 1322; upper pressing plate body 1322a; sub-upper pressing plate 1322b; lower pressing plate 1323; lower pressing plate body 1323a; sub-lower pressing plate 1323b; first clamping gap 1324; first support pipe 1325; second clamping unit 133; second tightening screw 1331; upper pressing block 1332; lower pressing block 1333; second clamping gap 1334; third tightening screw 1335; second support pipe 1336; third support pipe 1337; high-voltage lead 140; high-voltage terminal 141; low-voltage lead 150; low-voltage terminal 151; lifting assembly 160; lifting screw 161; suspension ring 162; upper bracket 170; upper bracket body 171; first bracket 1711; second bracket 1712; iron core pressing plate 172; insulating strut 180; groove 181.

### DETAILED DESCRIPTION

In order to make the above-mentioned objectives, features and advantages of the present disclosure more obvious and understandable, the specific embodiments of the present disclosure will be described in detail below in combination with the accompanying drawings. A lot of concrete details are described below so as to understand the present disclosure fully. However, the present disclosure may be implemented by adopting other manners different from the manner described herein, those having ordinary skill in the art may make similar improvements without violating the connotation of the present disclosure, and therefore the present disclosure is not limited by the specific embodiments disclosed below.

In the description of the present disclosure, it is understood that orientation or position relationships indicated by words such as “center”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise”, “anticlockwise”, “axial”, “radial”, “circumferential” and the like are based on the orientation or position relationships as shown in the drawings, for ease of describing the present disclosure and simplifying the description only, rather than indicating or implying that the mentioned apparatus or element necessarily has a particular orientation and must be constructed and operated in the particular orientation. Therefore, these terms should not be understood as limitations to the present disclosure.

In addition, words such as “first” and “second” and the like are merely used for description, instead of being understood as indicating or implying relative importance or impliedly indicating the quantity of the showed technical features. Thus, the features defined with “first” and “second” may expressly or impliedly one or more features. In the description of the present disclosure, the term “a plurality of” means at least two, such as two or three, unless specific limitation otherwise.

In the present disclosure, unless specific regulation and limitation otherwise, terms “install”, “join”, “connect”, “fix” and the like should be generally understood, for example, may be a fixed connection, a detachable connection, or integrated, may be a mechanical connection or an electric connection, may be a direct connection or an indirect connection through an intermediation, and may an internal connection of two elements or an interactive relationship of two elements, unless clearly specified otherwise. Those of ordinary skill in the art may understand the specific meaning of the terms in the disclosure according to specific conditions.

In the present disclosure, unless specific regulation and limitation otherwise, the first feature “onto” or “under” the second feature may include the direct contact of the first feature and the second feature, or indirect contact of the first feature and the second feature through an intermediation. Moreover, the first feature “onto”, “above” and “on” the second feature may be that the first feature is right above and obliquely above the second feature, or merely indicates that the horizontal height of the first feature is higher than the second feature. The first feature “under”, “below” and “down” the second feature may be that the first feature is right below and obliquely below the second feature, or merely indicates that the horizontal height of the first feature is less than the second feature.

It is to be noted that when one component is regarded to be “fixed” or “disposed” on another component, this component may be directly connected to other component or a mediate component may exist. When one component is regarded to be “connected” to another component, this component may be directly connected to other component or a mediate component may exist at the same time. Words such as “vertical”, “horizontal”, “upper”, “lower”, “left”, “right” and similar expressions used herein are merely for the purpose of description instead of the unique implementation mode.

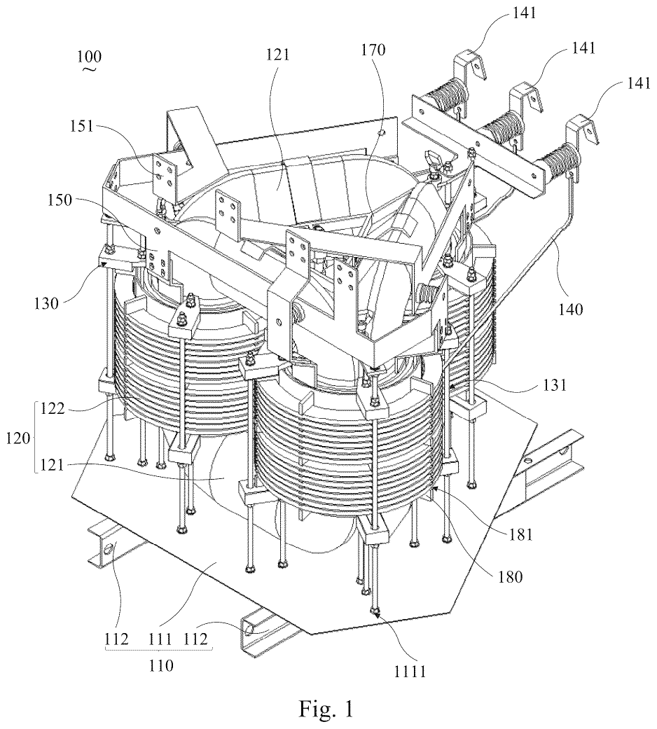

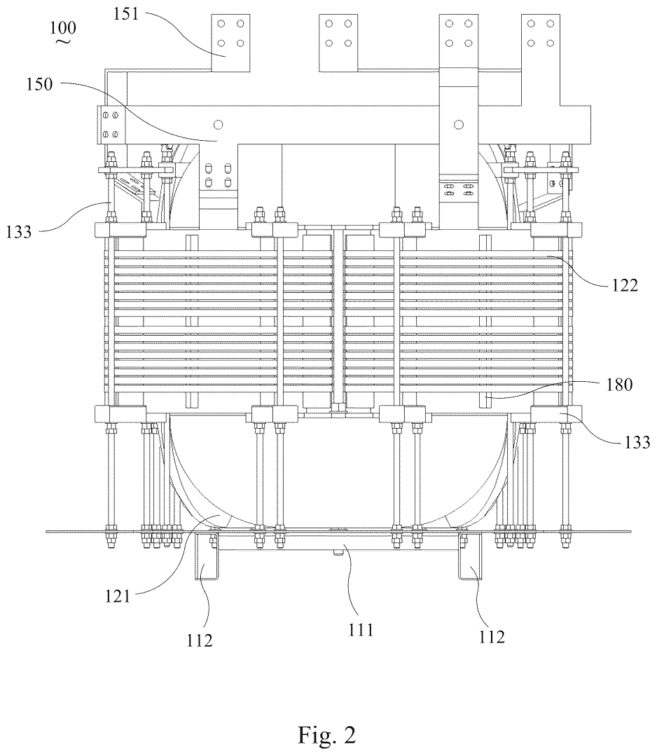

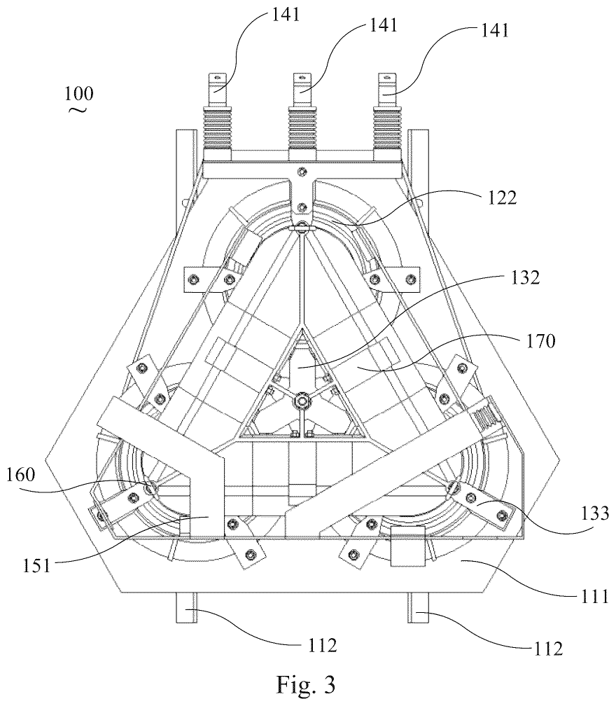

FIG. 1 shows an assembly schematic diagram of a transformer in an embodiment of the present disclosure. FIG. 2 shows a front view corresponding to FIG. 1. FIG. 3 shows a top view corresponding to FIG. 1.

Referring to FIGS. 1 to 3, the present disclosure provides a transformer 100, including a base 110, a transformer body 120, and a clamping assembly 130. The clamping assembly 130 is mounted on one side of the base 110. A clamping gap 131 is formed on the clamping assembly 130 in a vertical direction, and the clamping gap 131 is configured to clamp and support the transformer body 120.

Thus, the transformer body 120 can be clamped by the clamping assembly 130 to prevent the transformer body 120 from loosening. At the same time, the clamping assembly 130 is made of an insulating material, which will not cause harm to the environment and effectively solves the problems of long production process, high labor intensity, low efficiency and high cost of traditional clamps. In addition, the clamping assembly 130 provided by the present disclosure is unobstructed, which has a certain improvement on the heat dissipation effect of main heating elements such as the transformer core and coil.

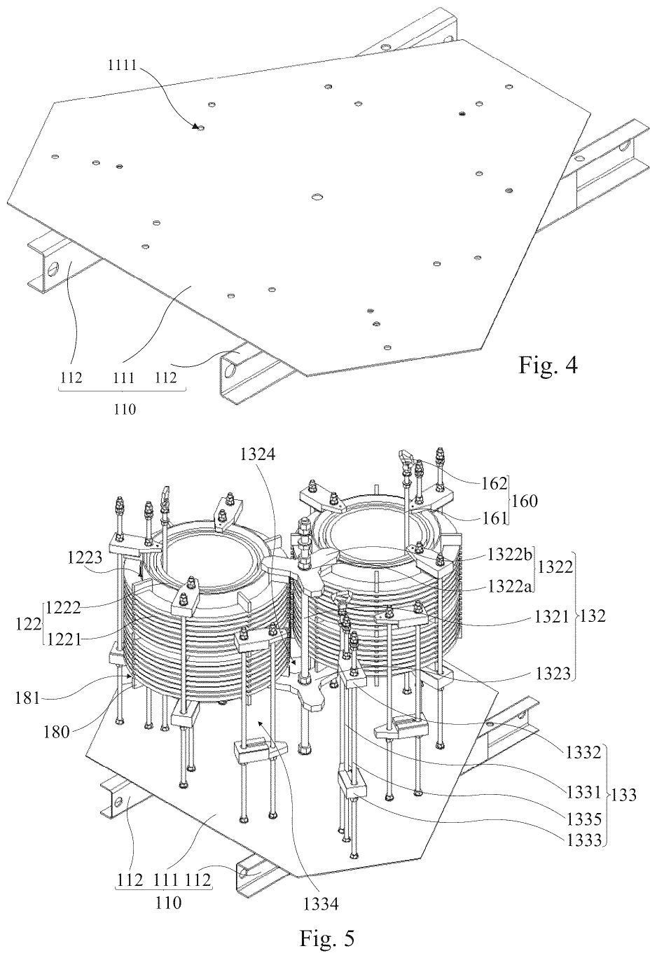

FIG. 4 shows a schematic structural diagram of a base in FIG. 1 according to the present disclosure.

Referring to FIG. 4 and in combination with FIGS. 1 to 3, the base 110 includes a bottom plate 111 and two support beams 112. The whole bottom plate 111 is a triangle-like platy structure, and the cross section of the bottom plate 111 is a hexagon. The bottom plate 111 span across the tops of the two support beams 112 in vertical directions. The bottom plate 111 has a plurality of mounting holes 1111 separated from each other for mounting the transformer body 120 and the clamping assembly 130. The support beams 112 are in a “C”-shaped structure as a whole. The two support beams 112 are spaced apart and arranged in parallel. The bottom plate 111 is connected to the two support beams 112 by fasteners.

In an embodiment, the support beams 112 are made of channel steel or bent steel plates. It should be appreciated that the formation method and material of the support beams 112 are not limited thereto and can be configured as needed to meet different requirements.

Thus, the bottom plate 111 is designed into a triangle-like hexagonal structure according to the overall outer profile of the transformer body 120, which can effectively reduce the outer dimensions of the transformer 100, and at the same time also save the transportation time of the transformer 100 and the mounting time that the transformer 100 is mounted at other locations.

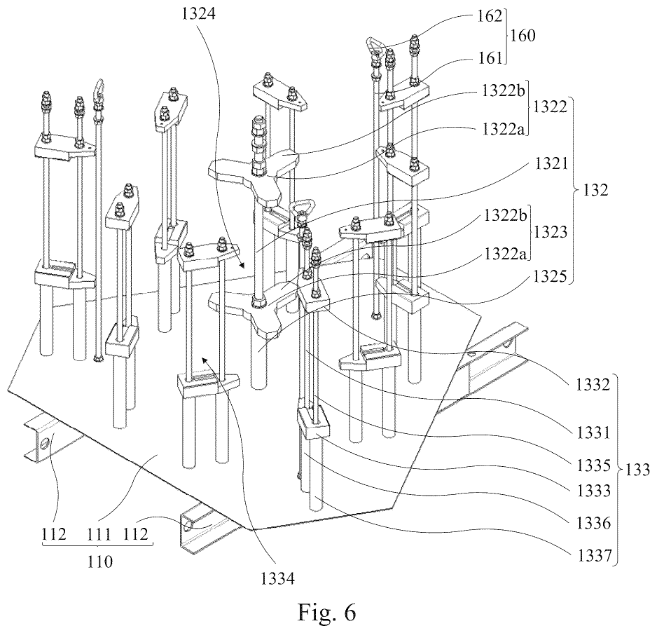

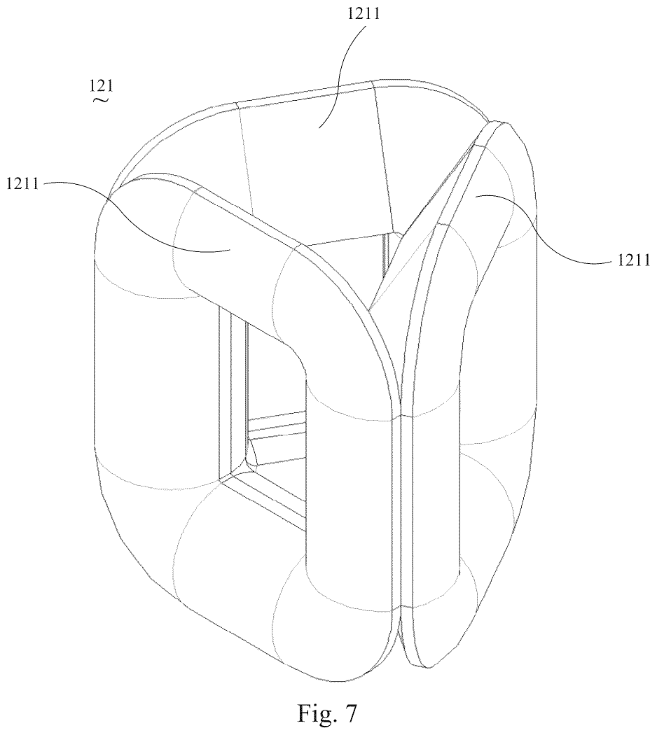

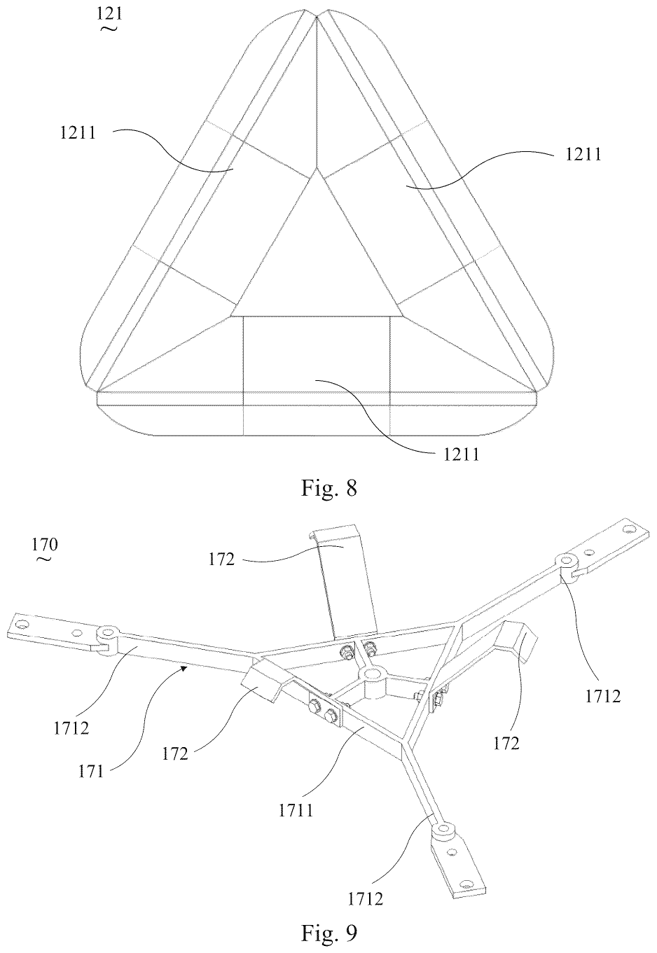

FIG. 5 shows a schematic diagram of a partial structure of a transformer corresponding to FIG. 1. FIG. 6 shows a schematic diagram of a partial structure of a transformer according to another embodiment of the present disclosure. FIG. 7 shows a schematic structural diagram of an iron core corresponding to FIG. 1. FIG. 8 shows a top view of an iron core corresponding to FIG. 7.

Referring to FIGS. 5 to 7, the transformer body 120 is disposed on one side of the base 110, supported on the clamping assembly 130 and clamped in the clamping gap 131. In an embodiment, the transformer body 120 includes an iron core 121 and a coil 122, and one end of the iron core 121 is disposed on the bottom plate 111. The coil 122 is in a cylindrical structure as a whole. The coil 122 is sleeved on the core column of the iron core 121. The coil 122 includes a primary coil 1221 and a secondary coil 1222. The primary coil 1221 is coated outside the secondary coil 1222 in a circumferential direction, and an insulating gap 1223 is formed between the primary coil 1221 and the secondary coil 1222. The insulating gap 1223 extends in the circumferential direction and penetrates through the secondary coil 1221 in the vertical direction. The height dimension of the secondary coil 1222 in the vertical direction is greater than that of the primary coil 1221 in the vertical direction.

In an embodiment, the iron core 121 is assembled from three single iron core frames 1211 with exactly identical geometric dimensions. The three single iron core frames 1211 are arranged in sequence around a central axis extending in the vertical direction. Two adjacent single iron core frames 1211 are connected to each other. When viewing from top to bottom in the vertical direction, the outer profiles of the three single iron core frames 1211 form an equilateral triangle together. The transformer body 120 includes three coils 122, which are all sleeved on the core column of the iron core 121. That is, each coil 122 is sleeved on the interconnection of two adjacent single iron core frames 1211, and each coil 122 includes a primary coil 1221 and a secondary coil 1222.

Thus, viewing from top to bottom in the vertical direction, the overall outer profile of the transformer body 120 is roughly an equilateral triangle. A structure of the iron core 121 formed by three single iron core frames 1211 connected to each other in pairs is conducive to enhancing the stability of the transformer body 120, and can effectively prevent the coil 122 from tipping over.

One end of the clamping assembly 130 is mounted on the base 110 and positioned on one side of the base 110 where the transformer body 120 is mounted. The other end of the clamping assembly 130 forms a clamping gap 131. The clamping gap 131 is configured to clamp and support the transformer body 120 in the vertical direction.

In an embodiment, the clamping assembly 130 is made of an insulating material.

Thus, the clamping assembly 130 and the bottom plate 111 form a support frame together, thereby effectively improving the overall strength of the transformer 100. The clamping assembly 130 can clamp and support the transformer body 120 by arranging the transformer body 120 in the clamping gap 131. In addition, the clamping assembly 130 made of the insulating material can avoid harm to the environment, which is beneficial to shortening the production process, reducing the labor intensity, improving the production efficiency and reducing the cost, and avoid the discharge of charged bodies such as the coil 122 or the lead wire of the transformer 100 to the clamping assembly 130 in certain fault conditions.

In an embodiment, the clamping assembly 130 includes a first clamping unit 132. One end of the first clamping unit 132 is mounted on one side, away from the support beams 112, of the bottom plate 111, and positioned at the center of the transformer body 120. The first clamping unit 132 includes a first tightening screw 1321, an upper pressing plate 1322 and a lower pressing plate 1323. The first tightening screw 1321 is cylindrical as a whole. The first tightening screw 1321 is mounted on the bottom plate 111 at one end of the first tightening screw 1321 through a fastener. The upper pressing plate 1322 and the lower pressing plate 1323 are sleeved on one end, away from the bottom plate 111, of the first tightening screw 1321 at intervals, and tightened through nuts. A first clamping gap 1324 is formed between one side, facing the lower pressing plate 1323, of the upper pressing plate 1322 and one side, facing the upper pressing plate 1322, of the lower pressing plate 1323. Moreover, the side, facing the lower pressing plate 1323, of the upper pressing plate 1322 is configured to compress an upper end face of the coil 122 in the vertical direction, and the side, facing the upper pressing plate 1322, of the lower pressing plate 1323 is configured to support an lower end face of the coil 122 in the vertical direction. The clamping gap 131 is formed in the first clamping gap 1324.

In an embodiment, the first tightening screw 1321, the upper pressing plate 1322 and the lower pressing plate 1323 are all made of insulating materials. The upper pressing plate 1322 includes an upper pressing plate body 1322a and three sub-upper pressing plates 1322b. The three sub-upper pressing plates 1322b are arranged at intervals in the circumferential direction and connected to the upper pressing plate body 1322a. One end, away from the upper pressing plate body 1322a, of each sub-upper pressing plate 1322b compresses the upper end face of one of the coils 122. The lower pressing plate 1323 includes a lower pressing plate body 1323a and three sub-lower pressing plates 1323b. The three sub-lower pressing plates 1323b are arranged at intervals in the circumferential direction and connected to the lower pressing plate body 1323a. One end, away from the lower pressing plate body 1323a, of each sub-lower pressing plate 1323b supports the lower end face of one of the coils 122. It should be appreciated that the upper pressing plate 1322 and the lower pressing plate 1323 may also be circular or in other shapes, as long as they can compress or support the three coils 122.

It should be noted that the transformer body 120 may include one or more coils 122, and correspondingly, the specific shapes of the upper pressing plate 1322 and the lower pressing plate 1323 may change accordingly. That is, the numbers of sub-upper pressing plates 1322b and sub-lower pressing plates 1323b are set correspondingly to the number of the coils 122, so that each sub-upper pressing plate 1322b and each sub-lower pressing plate 1323b correspond to one coil 122.

Thus, the first clamping unit 132 is arranged in such way that the three coils 122 are all disposed in the first clamping gap 1324, which can effectively compress the coils 122 to prevent the coils 122 from loosening, and the clamping force of the first clamping unit 132 clamping the coils 122 can be adjusted by adjusting the tightness of the nut. In addition, the insulating materials can improve the insulation reliability of the coils 122.

Referring to FIG. 6, in some embodiments, the first clamping unit 132 further includes a first support pipe 1325. The first support pipe 1325 is cylindrical as a whole. The first support pipe 1325 is sleeved on the first tightening screw 1321 and positioned between the lower pressing plate 1323 and the bottom plate 111. One side of the first support pipe 1325 abuts against one side, facing the first clamping unit 132, of the bottom plate 111, and the other side of the first support pipe 132 abuts against one side, facing the bottom plate 111, of the lower pressing plate 1323.

In an embodiment, the first support pipe 132 is made of an insulating material.

Thus, the first support pipe 132 can support the lower pressing plate 1322, and also serve as a reference for a mounting position of the lower pressing plate 1322 in the vertical direction. The first support pipe 132 is made of the insulating material, thereby further improving the insulation reliability of the coil 122.

In some embodiments, the clamping assembly 130 further includes a plurality of second clamping units 133 which are arranged at intervals in the circumferential direction and around an outer edge of the transformer body 120. Each of the second clamping units 133 includes a second tightening screw 1331, an upper pressing block 1332 and a lower pressing block 1333. The second tightening screw 1331 is cylindrical as a whole. The second tightening screw 1331 is mounted on the bottom plate 111 at one end of the second tightening screw 1331 through a fastener, and positioned at the insulating gap 1223 between the primary coil 1221 and the secondary coil 1222. The upper pressing block 1332 and the lower pressing block 1333 are sleeved on one end, away from the bottom plate 111, of the second tightening screw 1331 at intervals, and tightened by nuts. A second clamping gap 1334 is formed between one side, facing the lower pressing block 1333, of the upper pressing block 1332 and one side, facing the upper pressing block 1332, of the lower pressing block 1333. Moreover, the side, facing the lower pressing block 1333, of the upper pressing block 1332 is configured to compress the upper end face of the coil 122 in the vertical direction, and the side, facing the upper pressing block 1332, of the lower pressing block 1333 is configured to support the lower end face of the coil 122 in the vertical direction. The clamping gap 131 is formed in the second clamping gap 1334.

In an embodiment, the transformer body 120 includes three coils 122, and the clamping assembly 130 includes nine second clamping units 133. Each coil 122 has three second clamping units 133 at intervals in the circumferential direction. The second tightening screw 1331, the upper pressing block 1332 and the lower pressing block 1333 are all made of insulating materials. It should be appreciated that the number of the second clamping units 133 is not limited thereto and can be set according to the number of coils 122 and other needs to meet different requirements.

Thus, the second clamping units 133 is arranged in such way that the three coils 122 are in the second clamping gap 1334 along the circumferential direction, which can effectively compress the coil 122 to prevent the coils 122 from being tilted or even tipped over by using the first clamping unit 132 alone, and the clamping force of the second clamping units 133 clamping the coils 122 can be adjusted by adjusting the tightness of the nuts. Additionally, the insulating materials can improve the insulation reliability of the coils 122.

It should be noted that since the primary coil 1221 and the secondary coil 1222 have different heights in the vertical direction, the thicknesses of the upper pressing block 1332 and the lower pressing block 1333 in the vertical direction are not uniform. The thicknesses of the ends that the upper pressing block 1332 and the lower pressing block 1333 are in contact with the primary coil 1221 in the vertical direction are greater than that of the ends that the upper pressing block 1332 and the lower pressing block 1333 are in contact with the second coil 1222 in the vertical direction. The side, away from the lower pressing block 1333, of the upper pressing block 1332 and the side, away from the upper pressing block 1332, of the lower pressing block 1333 extend smoothly, while the side, facing the lower pressing block 1333, of the upper pressing block 1332 and the side, facing the upper pressing block 1332, of the lower pressing block 1333 have step surfaces.

In some embodiments, the second clamping units 133 further include a plurality of third tightening screws 1335. The number of the third tightening screws 1335 is the same as that of the second tightening screws 1335, and the plurality of third tightening screws 1335 are disposed outside the coil 122 at intervals along the circumferential direction. The third tightening screws 1335 are cylindrical as a whole, and one end of each of the third tightening screws 1335 is mounted on the bottom plate 111 and positioned outside of the coil 122. The third tightening screws 1335 and the second tightening screws 1332 are arranged at intervals, and both ends of the upper pressing block 1332 and the lower pressing block 1333 along their length directions are simultaneously sleeved on the second tightening screw 1332 and the third tightening screw 1335 and tightened by nuts.

Thus, the third tightening screws 1335 is arranged in such way that the clamping strength to the coils 122 can be further improved, thereby preventing the coils 122 from dispersing during transportation.

Referring to FIG. 6, in some embodiments, each of the second clamping units 133 further includes a second support pipe 1336 and a third support pipe 1337. The second support pipe 1336 is cylindrical as a whole. The second support pipe 1336 is sleeved on the second tightening screw 1331 and positioned between the lower pressing block 1333 and the bottom plate 111. One side of the second support pipe 1336 abuts against the side, facing the second clamping units 133, of the bottom plate 111, and the other side of the second support pipe 1336 abuts against the side, facing the bottom plate 111, of the lower pressing block 1333. The third support pipe 1337 is cylindrical as a whole. The third support pipe 1337 is sleeved on the third tightening screw 1335 and positioned between the lower pressing block 1333 and the bottom plate 111. One side of the third support pipe 1337 abuts against the side, facing the second clamping units 133, of the bottom plate 111, and the other side of the third support pipe 1337 abuts against the side, facing the bottom plate 111, of the lower pressing

In an embodiment, the second support pipe 1336 and the third support pipe 1337 are both made of insulating materials. The number of the second support pipe 1336 is the same as that of the second tightening screw 1331, and the second support pipe 1336 and the second tightening screw 1331 are arranged in a one-to-one correspondence. The number of the third support pipe 1337 is the same as that of the third tightening screw 1335, and the third support pipe 1337 and the third tightening screw 1335 are arranged in a one-to-one correspondence.

Thus, the second support pipe 1336 and the third support pipe 1337 can be configured to support the lower pressing block 1333 at the same time, and also serve as a reference for the mounting position of the lower pressing block 1333 in the vertical direction. The first support pipe 1325, the second support pipe 1336 and the third support pipe 1337 are set to the same height to ensure the stability of the coils 122. Moreover, the second support pipe 1336 and the third support pipe 1337 are both made of insulating materials, thereby further improving the insulation reliability of the coils 122. In some embodiments, the transformer 100 further includes a high-voltage lead 140 and a low-voltage lead 150. The high-voltage lead 140 is electrically connected to the outgoing line of the primary coil 1221 and forms a connection group required by the transformer 100. The high-voltage lead 140 also has a high-voltage terminal 141 for grid connection. The low-voltage lead 150 is electrically connected to the outgoing line of the secondary coil 1222 and forms a connection group required by the transformer 100. The low-voltage lead 150 has a low-voltage terminal 151 for grid connection.

Thus, the high-voltage lead 140, the low-voltage lead 150, the high-voltage terminal 141 and the low-voltage terminal 151 are arranged in such way that the transformer 100 can be used for grid connection.

In some embodiments, the transformer 100 further includes at least one lifting assembly 160. The lifting assembly 160 includes a lifting screw 161 and a suspension ring 162. The lifting screw 161 is cylindrical as a whole. One end of the lifting screw 161 is mounted on the bottom plate 111, and the lifting ring 162 is mounted on the other end of the lifting screw 161. The lifting assembly 160 is configured to lift and transport the transformer 100.

Thus, the transformer 100 can be lifted and transported by the lifting screw 161 and the suspension ring 162, so that it is simple and convenient to operate and can also avoid wasting time and labor when directly transporting the transformer 100.

FIG. 9 shows a schematic structural diagram of an upper bracket corresponding to FIG. 1.

Referring to FIG. 8, in an embodiment, the transformer 100 includes three lifting assemblies 160 mounted on the bottom plate 111 at intervals. Referring to FIG. 9, the transformer 100 further includes an upper bracket 170, which is sleeved on the first tightening screw 1321 of the first clamping unit 132 and positioned on one side, away from the lower pressing plate 1323, of the upper pressing plate 1322. The upper bracket 170 includes an upper bracket body 171 and an iron core pressing plate 172. The upper bracket body 171 is arranged on the clamping assembly 130, and the iron core pressing plate 172 is generally “L”-shaped as a whole. The iron core pressing plate 172 is mounted on the upper bracket body 171 for compressing the iron core 121.

In an embodiment, the upper bracket body 171 includes a first bracket 1711 and three second brackets 1712. The first bracket 1711 is generally a triangular frame structure as a whole and its cross section is an equilateral triangle. The three second brackets 1712 are connected to the three vertices of the first bracket 1711 along its circumferential direction, respectively. One end, away from the first bracket 1711, of each second bracket 1712 is sleeved on one of the lifting screws 161 and tightened by a nut, and the second bracket 1712 is positioned below the suspension ring 162 in the vertical direction. The upper bracket 170 includes three iron core pressing plates 172, which are mounted on the first bracket 1711 at intervals along the circumferential direction and configured to compress the three single iron core frames 1211, respectively. It should be appreciated that the number of the second brackets 1712 can be set according to the number of coils 122 and other needs to meet different requirements.

Thus, the three lifting screws 162 can be connected as a whole through the three second brackets 1712, thereby improving the strength of the lifting assembly 160 and preventing the lifting screw 161 from being deformed during the process of lifting the transformer 100. The iron core pressing plates 172 are compressed on the upper end face of the iron core 121 in the vertical direction, so as to prevent the iron core 121 from loosening during the transportation of the transformer 100.

Referring again to FIG. 1, FIG. 2 and FIG. 5, in some embodiments, the transformer 100 further includes a plurality of insulating struts 180, which are arranged at intervals along the circumferential direction and around the coils 122 and positioned in the insulating gap 1223.

In an embodiment, one end of each of the insulating struts 180 is mounted on the bottom plate 111, and a plurality of grooves 181 are formed in the other end of each of the insulating struts 180 at intervals. The openings of the grooves 181 face the primary coil 1221, and each primary coil 1221 is clamped into one groove 181. The insulating struts 180 are made of insulating materials, and each coil 122 has three insulating struts 180 at intervals along the circumferential direction thereof. The insulating struts 180 and the second clamping units 133 are arranged alternately at intervals.

Thus, the insulating struts 180 with the grooves 181 are arranged in such way that the primary coil 1221 can be effectively supported to prevent the primary coil 1221 from collapsing. At the same time, the insulating struts 180 made of the insulating materials can improve the insulation reliability of the transformer 100.

It should be noted that the transformer 100 provided by the present disclosure includes an iron core 121 and three coils 122, so the overall shapes of the base 110, the first clamping unit 132, and the upper bracket 170 provided in the embodiments of the present disclosure are all similar to triangles. The number of lifting assemblies 160 is also three. However, when the numbers of the iron core 121 and coils 122 included in the transformer 100 change, the above-mentioned technical solutions provided by the present disclosure can be used after simple changes. These technical solutions that are simply modified on the basis of the present disclosure still belong to the protection scope of the present disclosure.

The assembly steps of the transformer 100 provided by the present disclosure are as follows.

In a step S110, the base 110 is placed on an operating platform.

In a step S120, the first clamping unit 132 is mounted. In an embodiment, the first tightening screw 1321 passes through one of the plurality of mounting holes 1111 formed in the bottom plate 111, and then the first tightening screw 1321 is fixed to the bottom plate 111 by a nut. The first support pipe 1325 is sleeved on the first tightening screw 1321, and the lower end face of the first support pipe 1325 abuts against the bottom plate 111. The lower pressing plate 1323 is sleeved on the first tightening screw 1321 in such way that the lower end face of the lower pressing plate 1323 abuts against the upper end face of the first support pipe 1325, and then the lower pressing plate 1323 is fastened by the nut;

In a step of S130, the iron core 121 and the coil 122 are hoisted. In an embodiment, the iron core 121 and the coil 122 are hoisted onto the base 110, and the center of the iron core 121 is arranged to coincide with an axis of the first tightening screw 132. The iron core 121 is then fixed to the bottom plate 111 by the nut;

In a step of S140, the gap between the iron core 121 and the coil 122 is adjusted, and the second clamping unit 133 is mounted. In an embodiment, the second tightening screw 1331 stretches into the gap between the iron core 121 and the coil 122 from the top of the coil 122, and the lower pressing block 1333 and the second support pipe 1336 are sleeved on the second tightening screw 1331 in sequence. The upper end face and the lower end face of the lower pressing block 1333 abut against the coil 122 and the upper end face of the second support pipe 1336, respectively. The lower end face of the second support pipe 1336 abuts against the bottom plate 111, then the second tightening screw 1331 passes through the mounting hole 1111 formed in the bottom plate 111, and the second tightening screw 1331 is fixed to the bottom plate 111 by the nut. The third tightening screw 1335 stretches into the gap between the iron core 121 and the coil 122 from the top of the coil 122, and the lower pressing block 1333 and the third support pipe 1337 are sleeved on the third tightening screw 1335 in sequence. The upper end face and the lower end face of the third support pipe 1337 abut against the lower end face of the lower pressing block 1333 and the bottom plate 111, respectively. Then, the third tightening screw 1335 passes through the mounting hole 1111 formed in the bottom plate 111, and the third tightening screw 1335 is fixed to the bottom plate 111 by the nut. The upper pressing block 1332 is sleeved on the second tightening screw 1331 and the third tightening screw 1335, so that the lower end face of the upper pressing block 1332 abuts against the upper end face of the coil 122, and the upper pressing block 1332 is fastened by the nut.

In a step of S150, the upper pressing plate 1322 is mounted to be sleeved on the first tightening screw 1321, so that the lower end face of the upper pressing plate 1322 is allowed to abut against the upper end face of the coil 122, and the upper pressing plate 1322 is fastened through the nut.

In a step of S160, the upper bracket 170 is mounted to be sleeved on the first tightening screw 1321, the second tightening screw 1331 and the third tightening screw 1335, so that the upper bracket 170 is allowed to compress the upper top surface of the iron core 121, and the upper bracket 170 is tightened through the nut.

In summary, the present disclosure provides a transformer 100, in which the bottom plate 111 is designed as a triangle-like hexagonal structure, to effectively reduce the external dimensions of the transformer 100, save the transportation time of the transformer 100 and the mounting time that the transformer is mounted at other locations. The structure that three single iron core frames 1211 are connected to each other in pairs is conducive to enhancing the stability of the transformer body 120 and can effectively prevent the coil 122 from tipping over. The clamping assembly 130 and the bottom plate 111 form a support frame together, thereby effectively improving the overall strength of the transformer 100. The first clamping unit 132 and the second clamping unit 133 can clamp and support the coil 122 together to prevent the coil 122 from dispersing. The lifting screws 162 can be connected as a whole through the upper bracket 170, thereby improving the strength of the lifting assembly 160 and preventing the lifting screw 161 from deforming during the process of lifting the transformer 100. At the same time, the iron core 121 can also be compressed, to prevent the iron core 121 from loosening.

Each technical feature of the above embodiments may be combined freely. For simplicity of description, not all possible combinations of each technical solution in the above embodiments are described. However, any combination of these technical features shall fall within the scope recorded in the specification without conflicting.

The above embodiments only express some implementation modes of the present disclosure and are specifically described in detail and not thus understood as limitations to the patent scope of the present disclosure. It is to be pointed out that those having ordinary skill in the art may further make a plurality of variations and improvements without departing from the concept of the present disclosure and all of these fall within the protection scope of the present disclosure. Therefore, the scope of patent protection of the present disclosure should be subject to the appended claims.

What is claimed is:

1. A transformer, comprising:
a base;
a clamping assembly mounted on one side of the base, wherein a clamping gap is formed on the clamping assembly in a vertical direction; and
a transformer body supported on the clamping assembly and clamped in the clamping gap.

2. The transformer according to claim 1, wherein the clamping assembly comprises a first clamping unit which comprises a first tightening screw, an upper pressing plate and a lower pressing plate, the first tightening screw is mounted on the base at one end of the first tightening screw, and the upper pressing plate and the lower pressing plate are sleeved on the first tightening screw at intervals, so that a first clamping gap configured to clamp and support the transformer body is formed between one side, facing the lower pressing plate, of the upper pressing plate and one side, facing the upper pressing plate, of the lower pressing plate.

3. The transformer according to claim 1, wherein the clamping assembly further comprises a plurality of second clamping units which are arranged at intervals along a circumferential direction and around an outer edge of the transformer body.

4. The transformer according to claim 3, wherein each of the plurality of second clamping units comprises a second tightening screw, an upper pressing block and a lower pressing block, the second tightening screw is mounted on the base at one end of the second tightening screw, and the upper pressing block and the lower pressing block are sleeved on the second tightening screw at intervals, so that a second clamping gap configured to clamp and support the transformer body is formed between one side, facing the lower pressing block, of the upper pressing block and one side, facing the upper pressing block, of the lower pressing block.

5. The transformer according to claim 1, wherein the transformer body comprises:
an iron core arranged on the base; and
a coil sleeved on a core column of the iron core and comprising a primary coil and a secondary coil, wherein the primary coil is coated outside the secondary coil in a circumferential direction.

6. The transformer according to claim 5, further comprising a primary lead which electrically connects to an outgoing line of the primary coil, and comprises a primary terminal; and a secondary lead which electrically connects to an outgoing line of the secondary coil, and comprises a secondary terminal, wherein both the primary terminal and the secondary terminal are used for grid connection.

7. The transformer according to claim 1, wherein the base comprises a bottom plate and two support beams separated from each other, wherein the bottom plate spans across the two support beams, and the transformer body and the clamping assembly are mounted on one side of the bottom plate opposite the support beams.

8. The transformer according to claim 1, further comprising an upper bracket which comprises: an upper bracket body disposed on the clamping assembly, and an iron core pressing plate mounted on the upper bracket body to compress the iron core.

9. The transformer according to claim 1, further comprising a plurality of insulating struts which are arranged at intervals along a circumferential direction and around the transformer body.
